(19) United States
(12) Patent Application Publication
(10) Pub. No.: US 2004/0011337 A1
(43) Pub. Date: Jan. 22, 2004

(54) Fuel supply apparatus for a motor vehicle

(76) Inventor: Christoph Buehler, Gerlingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/362,011

(22) PCT Filed: Mar. 20, 2002
(86) PCT No.: PCT/DE02/01005

(51) Int. Cl. F02M 1/00; F04F 5/00

(52) U.S. Cl. 123/514; 417/151

(57) ABSTRACT

The fuel supply apparatus has a fuel tank (12), which has a number of partial regions (14, 16) whose bottoms (15, 17) are separate from one another and which contains a delivery unit (20) that supplies fuel at least indirectly from a first partial region (14) of the fuel tank (12) to an internal combustion engine (10) of the motor vehicle. A jet pump (40) delivers fuel from another partial region (16) of the fuel tank (12) into its first partial region (14), wherein the jet pump (40) has a propellant quantity supply unit (50) that supplies a propellant quantity of fuel to the jet pump (40), and wherein the jet pump (40) has a supply line (42, 56) through which the fuel supplied by the jet pump (40) travels into the first partial region (14) of the fuel tank (12). The propellant quantity supply unit (50) of the jet pump (40) has a pressure relief valve (70), which opens when a predetermined pressure is exceeded and permits a partial quantity of the propellant quantity of fuel supplied to the jet pump (40) to flow out, wherein the partial quantity of fuel diverted by the pressure relief valve (70) is supplied to the supply line (42, 56) of the jet pump (40) or is separately supplied to the first partial region (14) of the fuel tank (12).

### PRIOR ART

The invention is based on a fuel supply apparatus for a motor vehicle, as generically defined by the preamble to claim 1.

A fuel supply apparatus of this kind is known from DE 39 15 185 C1. This fuel supply apparatus has a fuel tank with a number of partial regions whose bottoms are separate from one another. The fuel supply apparatus also has a delivery unit, which supplies fuel from a first partial region of the fuel tank to an internal combustion engine of the motor vehicle. The first partial region of the fuel tank contains a collecting receptacle from which the delivery unit draws fuel. The fuel supply apparatus also has a jet pump, which supplies fuel from another partial region of the fuel tank into the first partial region or into the collecting receptacle contained in it. The jet pump has a propellant supply unit that supplies it with a propellant quantity for its operation. The jet pump also has a supply line through which both the propellant quantity and the quantity of fuel, which the jet pump draws from the other partial region of the fuel tank, travel into the first partial region or the collecting receptacle. The propellant quantity is supplied to the jet pump by means of a return line that sends fuel, which is supplied by the delivery unit, but unused by the internal combustion engine, back to the fuel tank. The return line can lead away from a pressure regulator that regulates the pressure of the fuel supplied to the internal combustion engine. The jet pump, however, can have a negative influence on the characteristics of the pressure regulator because the jet pump can produce a varying pressure in the return line depending on the propellant quantity with which it is supplied.

### ADVANTAGES OF THE INVENTION

The fuel supply apparatus according to the invention, with the characterizing features of claim 1, has the advantage over the prior art that the pressure relief valve limits the pressure generated in the propellant supply line by the jet pump and that the partial quantity of fuel diverted by the pressure relief valve is also used to fill the first partial region of the fuel tank.

Advantageous embodiments and modifications of the fuel supply apparatus according to the invention are disclosed in the dependent claims. The embodiment according to claim 2 assures the delivery unit of having a sufficient fuel supply from which to draw. The embodiments according to claims 4 and 5 permit a favorable efficiency of the jet pump to be achieved. The embodiment according to claim 6 permits the jet pump to be simply designed and easy to produce.

### DRAWINGS

An exemplary embodiment of the invention is shown in the drawings and will be explained in detail in the subsequent description.

FIG. 1 schematically depicts a fuel supply apparatus with a jet pump for an internal combustion engine of a motor vehicle and

FIG. 2 shows an enlarged longitudinal section through the jet pump.

### DESCRIPTION OF THE EXEMPLARY EMBODIMENT

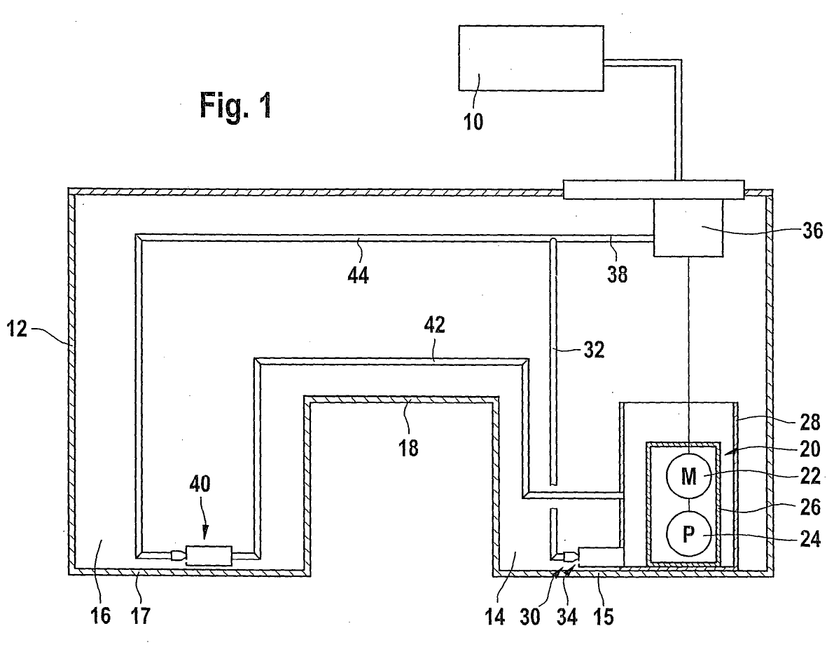

FIG. 1 shows a fuel supply apparatus for an internal combustion engine 10 of a motor vehicle. The internal combustion engine 10 has an injection apparatus that injects fuel into the cylinders of the engine. The fuel supply apparatus has a fuel tank 12 that has a number of partial regions 14, 16, for example two of them, whose bottoms 15, 17 are separate from each other. A hump or saddle 18 is provided between the partial regions 14, 16 and separates the bottoms 15, 17 from each other. The fuel supply apparatus has a delivery unit 20 in a first partial region 14 of the fuel tank 12 and this delivery unit 20 has an electric motor 22 as a drive unit, which drives a pump part 24. The electric motor 22 and the pump part 24 are disposed in a common housing 26. Preferably the first partial region 14 of the fuel tank 12 contains a cup-shaped collecting receptacle 28 whose volume is less than that of the first partial region 14. The delivery unit 20 draws fuel from the collecting receptacle 28 and supplies it to the internal combustion engine 10. The first partial region 14 of the fuel tank 12 contains a first jet pump 30, which feeds fuel from the partial region 14 into the collecting receptacle 28. The jet pump 30 is supplied via a line 32 with a propellant quantity of fuel, which causes additional fuel from the first partial region 14 to be drawn in through an intake opening 34 and fed into the collecting receptacle 28. The jet pump 30 can be contained in the collecting receptacle 28 or be separate from it.

The fuel supply apparatus can also have a pressure regulating device 36, which regulates the pressure of the fuel supplied to the internal combustion engine 10. The pressure regulating device 36 can be disposed inside the fuel tank 12 and has a return connection 38 through which the pressure regulating device 36 diverts fuel when the predetermined pressure is exceeded. The line 32 to the jet pump 30, which supplies this jet pump with the propellant quantity, can be connected to the return connection 38 of the pressure regulating device 36 so that the fuel quantity diverted by the pressure regulating device 36 is used as the propellant quantity for the jet pump 30. Alternatively, the line 32 to the jet pump 30 can also branch off from the pressure side of the delivery unit 20 upstream of the pressure regulating device 36 so that a part of the fuel supplied by the delivery unit 20 is used as the propellant quantity for the jet pump 30. In this case, it is also possible to eliminate the pressure regulating device 36.

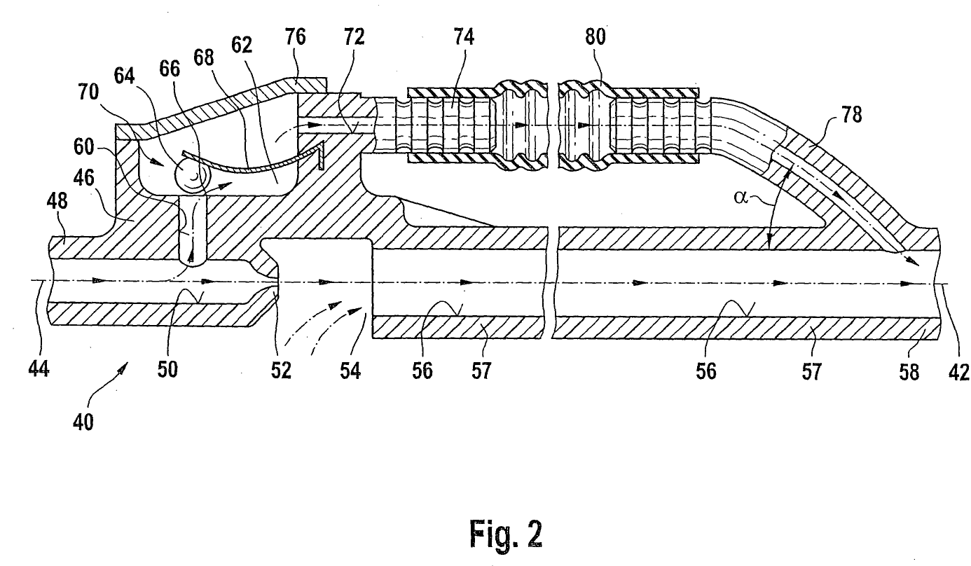

The second partial region 16 of the fuel tank 12 contains another jet pump 40, which delivers fuel from the second partial region, over the saddle 18 via a supply line 42, and into the first partial region 14. The supply line 42 can feed into the first partial region 14 or into the collecting receptacle 28 contained in it. A line 44 supplies the jet pump 40 with the propellant quantity required for its operation. The line 44 can be connected to the return connection 38 of the pressure regulating device 36. FIG. 2 shows an enlarged depiction of the jet pump 40 and the jet pump 40 will be explained in detail below in conjunction with this depiction.

The jet pump 40 has a base body 46, which is preferably made of plastic and is produced by means of injection molding. The base body 46 has a connection 48, for example in the form of a fitting, for the line 44 that supplies the propellant quantity to the jet pump 40. Leading from the connection 48, the base body 46 contains a conduit 50, which narrows to form a nozzle 52 at an end oriented away from the connection 48. The nozzle 52 can be of one piece with the base body 46 or can be inserted into the conduit 50 as a separate part. An intake opening 54 of the jet pump 40 is situated downstream of the nozzle 52, in the direction oriented away from the conduit 50. On its side oriented away from the nozzle 52, the intake opening 54 is adjoined by another conduit 56, which is embodied in a tubular extension 57 of the base body 46. The conduit 50, the nozzle 52, and the conduit 56 are disposed at least approximately coaxial to one another. At its end oriented away from the intake opening 54, the conduit 56 feeds into a connection 58, for example in the form of a fitting, for the supply line 42.

Upstream of the nozzle 52, a relief conduit 60 in the base body 46 branches off from the conduit 50 and feeds into a recess 62 provided in the base body 46. For example, the relief conduit 60 extends approximately perpendicular to the conduit 50, but can also extend at an arbitrary inclination in relation to the conduit 50. The recess 62 contains a closing element 64, for example in the form of a ball, which can close the relief conduit 60. The closing element 64 cooperates with the mouth 66 of the relief conduit 60 acting as a valve seat in the recess 62. A prestressed spring 68 presses the closing element 64 against the valve seat 66. The spring 68 can be embodied, for example, as a leaf spring that is clamped at one end in the base body 46 and engages the closing element 64 with its free end. The relief conduit 60, the closing element 64, and the spring 68 constitute a pressure relief valve 70; this pressure relief valve 70 opens and permits a part of the propellant quantity supplied to the jet pump 40 to flow out when a pressure is exceeded in the conduit 50 of the jet pump 40, said pressure being determined by the initial stress of the spring 68 and said conduit constituting the propellant quantity supply unit of the jet pump.

A conduit 72 leads away from the recess 62 and feeds into a connection 74, e.g. in the form of a fitting. For example, the conduit 72 extends approximately parallel to the conduit 50, but can also extend inclined at an arbitrary angle in relation to the conduit 50. The recess 62 is closed tightly by a cover 76, which is attached to the base body 46, for example by being glued or welded to it.

Spaced apart from the intake opening 54, the tubular extension 57 of the base body 46 is provided with a fitting 78, which feeds into the conduit 56. The fitting 78 is inclined in relation to the conduit 56 by an acute angle α with regard to the flow direction of the fuel in the conduit 56. The fitting 78 is preferably of one piece with the tubular extension 57, but can also be connected to it as a separate part. A line 80 is slid onto the fitting 78 and its other end is slid onto the fitting 74. The through flow cross section of the fitting 78 is preferably smaller than the through flow cross section of the conduit 56. The through flow cross section of the fitting 78 and the angle a at which it is inclined in relation to the conduit 56 are selected so as to provide the jet pump 40 with the greatest possible efficiency. The supply line 42 of the jet pump 40 is connected to the tubular extension 57 containing the conduit 56 and this conduit 56 constitutes a part of the supply line 42 from the jet pump 40 to the first partial region 14 of the fuel tank 12.

The function of the jet pump 40 will be explained below. The propellant quantity of fuel supplied to the jet pump 40 via the line 44 flows through the conduit 50 and emerges from it by means of the nozzle 52. Due to the reduced through flow cross section of the nozzle 52, the fuel is accelerated so that fuel from the second partial region 16 of the fuel tank 12 is drawn in through the intake opening 54. Both the propellant quantity of fuel emerging from the nozzle 52 and the quantity of fuel drawn in through the intake opening 54 enter the conduit 56 of the tubular extension 57 and travel through the supply line 42 into the first partial region 14 of the fuel tank 12 or into the collecting receptacle 28 contained in it. If the pressure in the conduit 50 of the jet pump 40 is less than the opening pressure of the pressure relief valve 70, then this valve is closed so that no fuel can flow out through the relief conduit 60. The total propellant quantity supplied to the jet pump 40 then travels through the nozzle 52.

If the pressure in the conduit 50 of the jet pump 40 exceeds the opening pressure of the pressure relief valve 70, then this valve opens and fuel flows out of the conduit 50. Then only part of the propellant quantity of fuel supplied to the jet pump 40 travels through the nozzle 52. The partial quantity of fuel diverted by the open pressure relief valve 70 is supplied to the conduit 56 via the line 80 and the fitting 78. The fuel quantity fed through the jet pump 40 is reduced when the pressure relief valve 70 is open since the partial quantity of fuel diverted by the pressure relief valve 70 is not used for the fuel delivery, but travels instead directly into the first partial region 14 of the fuel tank 12 or into the collecting receptacle 28 contained in it. However, the partial quantity of fuel diverted by the pressure relief valve 70 does not travel into the second partial region 16 of the fuel tank 12, but is instead used to fill the first partial region 14 or the collecting receptacle 28 contained in it.

Alternative to the embodiment explained above, the fitting 78 on the tubular extension 57 of the base body 46 of the jet pump 40 can also be eliminated and the partial quantity of fuel diverted by the pressure relief valve 70 is supplied via a separate supply line to the first partial region 14 of the fuel tank 12 or the collecting receptacle 28 contained in it.

The pressure relief valve 70 sets an at least approximately constant pressure in the conduit 50 of the jet pump 40 and the line 44 feeding into it. This prevents the negative repercussions on the pressure regulating device 36 that could occur if the pressure in the jet pump 40 were to vary.

1. A fuel supply apparatus for a motor vehicle, with a fuel tank (12) that has a number of partial regions (14, 16) whose bottoms (15, 17) are separate from one another, with a delivery unit (20) that supplies fuel at least indirectly from a first partial region (14) of the fuel tank (12) to an internal combustion engine (10) of the motor vehicle, and with a jet pump (40) that delivers fuel from another partial region (16) of the fuel tank (12) into its first partial region (14), wherein the jet pump (40) has a propellant quantity supply unit (50) that is connected to a line (44) and supplies a propellant quantity of fuel to the jet pump (40), and wherein the jet pump (40) has a supply line (42) through which the fuel supplied by the jet pump (40) travels into the first partial region (14) of the fuel tank (12), characterized in that the propellant quantity supply unit (50) of the jet pump (40) has a pressure relief valve (70), which opens when a predetermined pressure is exceeded and permits a partial quantity of the propellant quantity of fuel supplied to the jet pump (40) to flow out, and in that the partial quantity of fuel diverted by the pressure relief valve (70) is supplied to the supply line (42, 56) of the jet pump (40) or is separately supplied to the first partial region (14) of the fuel tank (12).

2. The fuel supply apparatus according to claim 1, characterized in that the first partial region (14) of the fuel tank (12) contains a collecting receptacle (28) from which the fuel delivery unit (20) draws fuel, and in that the jet pump (40) feeds fuel into the collecting receptacle (28).

3. The fuel supply apparatus according to claim 2, characterized in that the partial quantity of fuel diverted by the pressure relief valve (70) is supplied to the collecting receptacle (28).

4. The fuel supply apparatus according to claim 1 or 2, characterized in that the partial quantity of fuel diverted by the pressure relief valve (70) is supplied via a line (78, 80) to the supply line (42, 56) of the jet pump (40), and in that the line (78) feeds into the supply line (42, 56) at an acute angle (α).

5. The fuel supply apparatus according to claim 4, characterized in that in the vicinity of the point at which it feeds into the supply line (42, 56), the line (78, 80) has a smaller through flow cross section than the supply line (42, 56).

6. The fuel supply apparatus according to claim 4 or 5, characterized in that the jet pump (40) has a base body (46), which is of one piece with the propellant quantity supply unit (50) a part (56, 67) of the supply line (42), and in that the part (56, 57) of the supply line (42) is of one piece with a connection fitting (78) for the line (80) that carries the partial quantity of fuel diverted by the pressure relief valve (70).

7. The fuel supply apparatus according to one of claims 1 to 6, characterized in that it has a pressure regulating device (36) that regulates the pressure of the fuel supplied to the internal combustion engine (10), and in that the fuel quantity diverted by the pressure regulating device (36) is supplied to the jet pump (40) as a propellant quantity.
